(19) United States
(12) Patent Application Publication
(10) Pub. No.: US 2026/0368099 A1
(43) Pub. Date: Nov. 19, 2026

(54) APPARATUS WITH MEMORY-LOCAL CACHE AND METHODS FOR OPERATING THE SAME

(71) Applicant: Micron Technology, Inc., Boise, ID (US)

(72) Inventors: Chetan Chauhan, Folsom, CA (US); Raymond Chang, Sacramento, CA (US); Raghukiran Sreeramaneni, Frisco, TX (US); Nevil N. Gajera, Meridian, ID (US)

(21) Appl. No.: 19/656,672

(22) Filed: Apr. 23, 2026

Related U.S. Application Data
(60) Provisional application No. 63/806,261, filed on May 15, 2025.

(51) Int. Cl. G06F 12/0897; G06F 12/0866; G06F 13/16

(52) U.S. Cl. CPC G06F 12/0897; G06F 12/0866; G06F 13/1684; G06F 13/1689

(57) ABSTRACT

Methods, apparatuses, and systems related to a memory-local cache on an interface die are described. Operations of the memory-local cache array may be further facilitated by a channel selection circuit within the host device or the interface die.

### CROSS-REFERENCE TO RELATED APPLICATION(S)

The present application claims priority to U.S. Provisional Patent Application No. 63/806,261, filed May 15, 2025, the disclosure of which is incorporated herein by reference in its entirety.

### TECHNICAL FIELD

The disclosed embodiments relate to devices, and, in particular, to semiconductor memory devices with memory-local cache and methods for operating the same.

### BACKGROUND

An apparatus (e.g., a processor, a memory system, and/or other electronic apparatus) can include one or more semiconductor circuits configured to store and/or process information. For example, the apparatus can include a memory device, such as a volatile memory device, a non-volatile memory device, or a combination device. Memory devices, such as dynamic random-access memory (DRAM), can utilize electrical energy to store and access data.

With technological advancements in embedded systems and increasing applications, the market is continuously looking for faster, more efficient, and smaller devices. To meet the market demands, the semiconductor devices are being pushed to the limit with various improvements. Improving devices, generally, may include increasing circuit density, increasing operating speeds or otherwise reducing operational latency, increasing reliability, increasing data retention, increasing functionalities, reducing power consumption, or reducing manufacturing costs, among other metrics.

### BRIEF DESCRIPTION OF THE DRAWINGS

Detailed descriptions of implementations of the present invention will be described and explained through the use of the accompanying drawings.

FIG. 1A is a cross-sectional view of an example system-in-package (SiP) device.

FIG. 1B is a schematic block diagram of a processor and a memory device.

FIG. 1C is a circuit diagram of the processor and the memory device.

FIG. 2A is a cross-sectional view of a SiP device in accordance with an embodiment of the present technology.

FIG. 2B is a schematic block diagram of a processor and a memory device in accordance with an embodiment of the present technology.

FIG. 2C is a circuit diagram of the memory device of FIG. 2B in accordance with an embodiment of the present technology.

FIG. 3A is a detailed circuit diagram of a first example of a memory-local cache in accordance with an embodiment of the present technology.

FIG. 3B is a detailed circuit diagram of a second example of a memory-local cache in accordance with an embodiment of the present technology.

FIG. 4A is a flow diagram illustrating an example method of manufacturing an apparatus in accordance with an embodiment of the present technology.

FIG. 4B is a flow diagram illustrating an example method of operating an apparatus in accordance with an embodiment of the present technology.

FIG. 5 is a schematic view of a system that includes an apparatus in accordance with an embodiment of the present technology.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

As described in greater detail below, the technology disclosed herein relates to an apparatus (e.g., memory systems, systems with memory devices, related methods, etc.) having memory-local cache (e.g., Static Random Access Memory (SRAM)) outside of the corresponding host/processor. For example, the apparatus can include a High-Bandwidth Memory (HBM) device that has one or more core dies stacked on an interface die. The interface die can include a circuit interface fabric that facilitates communication between a locally implemented memory controller (e.g., residing on/within the interface die) and the inter-die connections (e.g., Through Silicon Vias (TSVs)) that communicatively couple the core dies to the interface die. The HBM device can be physically separate from a corresponding host processor (e.g., a graphics processing unit (GPU)) that is coupled through external connections (e.g., through microbumps and internal connections, such as traces and/or vias, within an interposer). Moreover, the HBM device and the host processor can be communicatively coupled using a device-to-device physical layer (PHY) that corresponds to transceivers configured according to a communication protocol or setting (e.g., frequency, bus/channel width, signaling patterns, etc.).

The interface die can further include a memory-local cache, such as cache memory located outside of the host processor and before the locally implemented memory controller, such that the cache memory is configured to provide additional high-speed data capacity to the host processor. The cache memory local to the memory device can be in addition to and/or an extension of cache memory (e.g., L2/L3 cache) local to the host processor. Accordingly, the host processor can access the memory-local cache (e.g., the cache memory located on the HBM interface die) using the PHY and without the memory controller on the interface die.

The memory-local cache may be placed outside of and accessible by the host controller by having the memory controller at the memory side (e.g., at the interface die of the HBM). Moreover, the memory controller can be implemented at the memory side by using the circuit interface fabric (e.g., communication and/or routing circuitry) between the memory controller and the connections to the memory cells (e.g., the TSVs connecting the interface die to the core dies). Thus, together with the memory-local controller and the interface fabric, the memory-local cache provides additional cache memory for the host processor. Thus, the memory device can provide a set of memory/cache that are directly accessible (e.g., without utilizing the memory controller) to the external host processor and, as a result, much faster than the memory cells in the core dies.

Conventional host devices (e.g., a CPU, a GPU, etc.) often require frequent and rapid use of compact data stored in small memory arrays (e.g., a cache memory) to execute compute processes. However, communication between the host device and an HBM memory device (e.g., for implementing similar memory operations at the core dies) is often slow and inefficient in comparison to cache access. Further, the physical space within the host processor is limited, and increasing the faster storage capacity or the cache memory onboard the host processor is difficult and expensive.

In contrast, embodiments of the present technology provide additional fast memory by providing the memory-local cache within the interface die and prior to the memory controller. Since the host processor can directly access the memory-local cache without the memory controller, the memory-local cache provides significant reduction in the overall latency (e.g., by a factor of three or more) compared to the core die access. Additional benefits of the memory-local cache include a significant reduction of overall power consumption by the memory device and increase in the overall memory capacity of the memory device (e.g., memory accessible to the host processor) and the cache memory size for the host processor.

In some embodiments, the memory-local cache of the interface die can be configured to use a persistence flag to store or retain within the memory-local cache data (e.g., via tracking memory cells and/or channels flagged for persistent storage) received from the host device. The host processor and/or a management circuitry in the memory device can flag certain data (e.g., frequently accessed or key data), and the flagged data can be retained without being flushed out. As a result, the cache memory can enable host devices (e.g., a GPU) to rapidly and efficiently read static data (e.g., a neural network weight matrix) from the memory-local cache for downstream computing processes (e.g., generating output inference data).

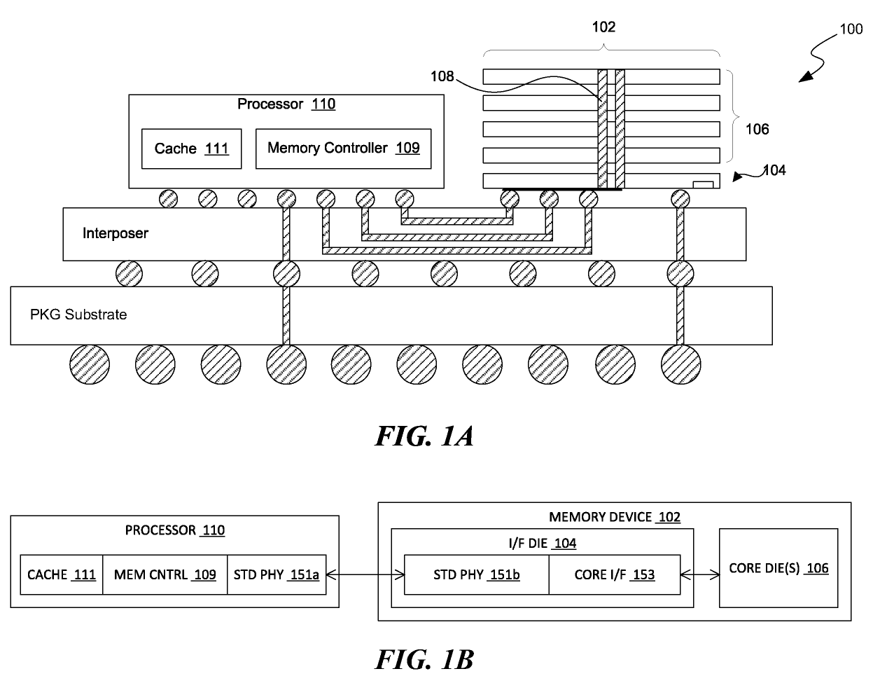

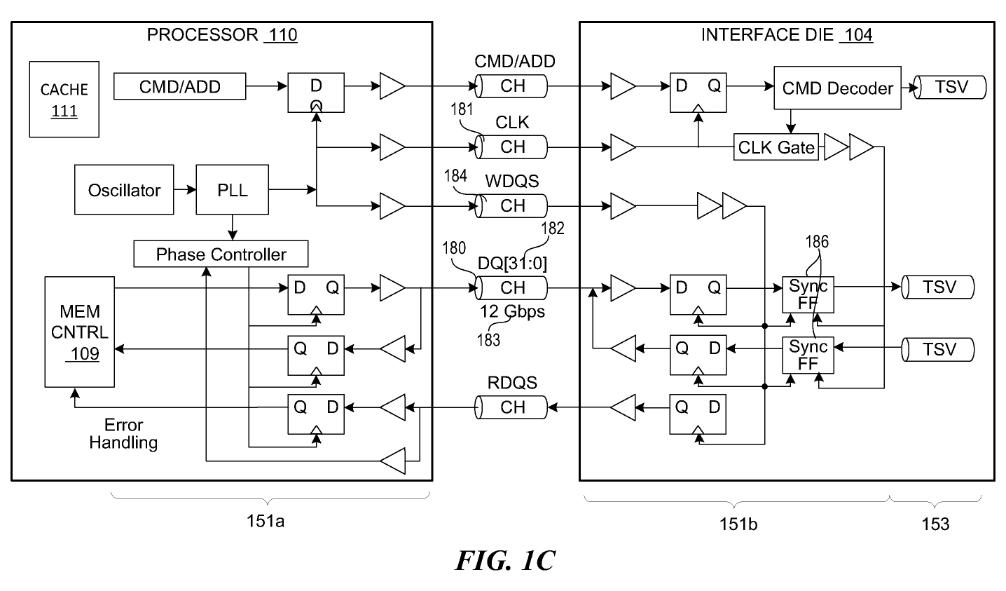

For context, conventional computing devices (e.g., a System-In-Package (SiP) devices) have the memory controller and the cache memory located within and limited to a processor. FIG. 1A illustrates a schematic cross-sectional view of a SiP 100 device. The SiP 100 can include a memory device 102 and a processor 110 (e.g., a central processing unit (CPU), a GPU, or the like), which are packaged together on a package substrate along with an interposer. The processor 110 may act as a host device of the SiP 100.

In some embodiments, the memory device 102 may be a HBM device that includes an interface die (or logic die) 104 and one or more memory core dies 106 stacked on the interface die 104. The memory core dies 106 can include DRAM devices/dies, NAND devices/dies, and/or other types of memory devices (e.g., static RAM (SRAM)) as main memory configured to store data provided by the processor 110 and to provide access of the stored data to the processor 110. The memory device 102 can further include additional and/or supplementary memory circuits (e.g., SRAM, DRAM, NAND, etc.), located within and/or outside of the core dies 106, configured for internal uses (e.g., remaining inaccessible to the processor 110). The memory device 102 can include one or more through silicon vias (TSVs) 108, which may be used to couple the interface die 104 and the core dies 106.

The processor 110 can further include a memory controller 109. In other words, the memory controller 109 can be external to the memory device 102 and be implemented as circuitry within the same package as the processor 110. The memory controller 109 can include a circuit configured to control and manage the flow of data going to and from the memory device 102 and the processor 110. The memory controller 109 can manage memory mappings, such as between virtual and physical addresses, and perform the corresponding translations. Accordingly, the memory controller 109 can issue commands, such as reads, memory management functions (e.g., refresh), and/or the like, to the memory device 102 using the physical memory addresses. Moreover, the memory controller 109 can map the read data into virtual addresses so that the processor 110 can operate on the requested data (e.g., according to the virtual addresses).

Illustrating additional details of the memory controller 109, FIG. 1B is a schematic block diagram of a processor (e.g., the processor 110) and a memory device (e.g., the memory device 102). The processor 110 can include a physical layer interface circuit (PHY) 151a, such as transmitters, receivers, signal drivers, and/or the like, configured to facilitate the exchange of electrical signals with the memory device 102. The PHY 151a can be coupled to and controlled by the memory controller 109. For the SiP 100 (e.g., Artificial Intelligence (AI) processing devices) including the HBM, the PHY 151a can be configured according to Joint Electron Device Engineering Council (JEDEC) standards regarding HBM communications.

Additionally, the processor 110 can include processor-local cache memory 111. The processor-local cache memory 111 can include relatively smaller and faster (e.g., in comparison to RAM) memory circuit configured to store frequently used data and instructions. The processor-local cache memory 111 can be organized into various levels, such as L1, L2, and/or L3, according to access speed and/or size. In accessing the data, the processor 110 can first check the cache, such as starting at the fastest/smallest level. If the targeted data is stored at the particular cache location (e.g., a “hit”), the data is accessed from the cache (e.g., from the searched level). If the data is not found, the processor 110 can successively move to a larger/slower level (e.g., from L1 cache to L2 and then L3) until the data is found.

The PHY 151a can be coupled to the memory device 102 and the interface die 104 therein using channels or similar connections within the interposer. The interface die 104 can include a complementary PHY 151b circuit that implements the communications for the memory device 102. Accordingly, the PHY 151b can match or correspond to the PHY 151a. For example, the PHY 151b can be configured according to the JEDEC HBM standards.

Internally, the PHY 151a can be coupled to the core dies 106 through a core interface 153, such as the TSVs 108 of FIG. 1A. Accordingly, the PHY 151a can further manage the communications to and from the core dies 106.

When the processor 110 determines that the targeted data is not stored in the processor-local cache memory 111, the processor can communicate with the memory device 102 (e.g., corresponding to the DRAM that is after the processor-local cache memory 111 in the speed/size hierarchy) to access the targeted data. The processor 110 can access the targeted data by going through the memory controller 109 and then communicating signals over the PHY 151a/151b to access the core dies 106 at the memory device 102.

As a further detailed example, FIG. 1C is a circuit diagram of the processor 110 and the memory device 102 (e.g., the interface die 104 therein). The PHY 151a of FIG. 1B can correspond to the flip flops and the drivers, the phase-locked loop (PLL) circuit, the phase controller, and/or the oscillator in the processor 110.

The memory controller 109 (e.g., the DRAM controller) can provide the write data to the PHY 151a along with a corresponding command and address (CMD/ADD). The command and address can be communicated through corresponding channel(s) to a receiver circuit within the PHY 151b of the interface die 104. The PLL can provide a corresponding clock (CLK) 181 used to read the bits/transitions within the command and addresses. Further, the PLL and the Phase controller can provide a timing signal internal to the PHY 151a for driving the data (e.g., DQ) outputs, such as the data/payload targeted for the write. Using the timing signal, the PHY 151a can drive and send the write data over DQ channel(s) a DQ bus 180 to the PHY 151b of the interface die. In coordinating the communication/timing of the data, the PLL can further provide a write data strobe signal (WDQS) 184 over corresponding channel(s).

As described above, the PHY 151b can receive the command and address and the payload data associated with the write command. The PHY 151b can further receive the timing signals, such as the CLK and the WDQS. The PHY 151b can include receivers, flip flops, gates, decoders, and the like configured to receive and process the write command and data according to the timing signals. The command decoder can be configured to identify the physical location, such as the chip/core die indicated by the address and the location within the die (e.g., channel, bank, row, column, and/or the like). The command decoder can provide the corresponding notification (e.g., enable, address communication, and/or the like) to the targeted core die through corresponding TSV(s). The command decoder can further control and enable the receiver circuitry to receive the write data. The write data can be provided to the targeted die through corresponding TSV(s), and the targeted die can perform the internal operations to write the data at the commanded address. In internally communicating the write data, the PHY 151b can include synchronizing flip flops (FFs) 186 configured to synchronize and align the WDQS with the CLK.

For read commands, the memory controller 109 can provide the read command and the targeted addresses similarly as for the write. The memory controller 109 can effectively trigger the PLL to provide the timing signals as described for the write.

In providing the read data back to the processor 110, the PHY 151b in the interface die can identify the targeted die and location within the targeted die, and the corresponding die can read back the information from the commanded location. The read data can be provided from the targeted core die to the interface die through corresponding TSVs. The PHY 151b can use the WDQS to time the communication of the read data and further provide a read data strobe signal (RDQS) over corresponding channel(s) to the PHY 151a. The synchronizing FFs 186 can perform the alignment for the read data similarly as the write data.

The read data can be provided over the same channel(s) (e.g., the DQ bus 180 having a bus width 182 of [31:0] bits at a communication speed 183 of 12 Gbps per JEDEC HBM) as the write data. Stated differently, the PHY 151a and the PHY 151b can be connected through a bi-directional data bus used to communicate both the read data (e.g., to the PHY 151a) and the write data (to the PHY 151b).

To process the read data, the PHY 151b can include a receiver and a corresponding circuit path different from those of the write circuitry. The read data can be received according to the RDQS signal and provided to the memory controller 109.

### Example Environment

In contrast to the conventional computing devices, embodiments of the present technology can include memory-local cache remaining before a memory controller, both of which are implemented at the memory device and outside of the processor. The memory controller and the memory-local cache can be implemented at the memory device, such as at the interface die of the HBM based on the circuit interface fabric. Moreover, based on having the memory-local cache at the interface die of the memory device, the memory device and the processor can exchange or communicate data stored in the intermediary cache memory.

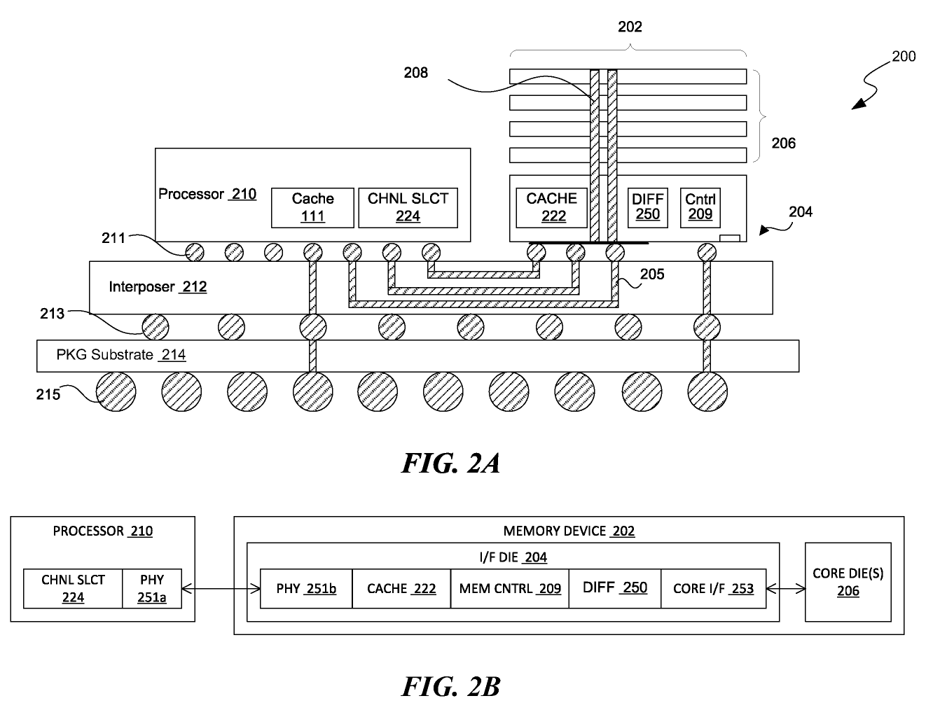

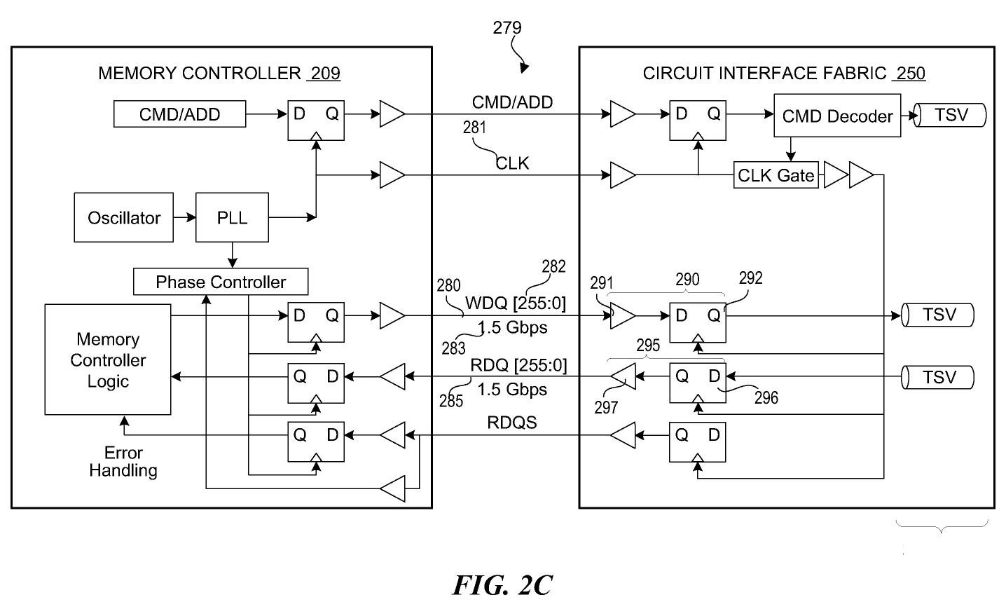

To illustrate the memory-local cache and the corresponding direct communication of data between the processor and the interface die of the memory device, the FIG. 2A is a cross-sectional view of a SiP 200 device (i.e., an example apparatus) in accordance with embodiments of the technology. The SiP 200 can include a memory device 202 and a processor 210 (e.g., a CPU, a GPU, or the like), which are packaged together on a package substrate 214 along with an interposer 212. The processor 210 may act as a host device of the SiP 200. Further, similar to the processor 110 of FIG. 1A, the processor 210 can include onboard cache (processor-local cache memory) 111. For example, the processor-local cache memory 111 can include SRAM arranged as L1, L2, and/or L3 cache.

In some embodiments, the memory device 202 may be a HBM device that includes an interface die (or logic die) 204 and one or more memory core dies 206 stacked on the interface die 204. The memory core dies 206 can include DRAM devices/dies, NAND devices/dies, and/or other types of memory devices (e.g., SRAM) as main memory configured to store data provided by the processor 210 and to provide access of the stored data to the processor 210. The memory device 202 can further include additional and/or supplementary memory circuits (e.g., SRAM, DRAM, NAND, etc.), located within and/or outside of the core dies 206, configured for internal uses (e.g., remaining inaccessible to the processor 210). The memory device 202 can include one or more TSVs 208, which may be used to couple the interface die 204 and the core dies 206.

The interposer 212 (e.g., a silicon interposer) can provide electrical connections between the processor 210, the memory device 202, and/or the package substrate 214. For example, the processor 210 and the memory device 202 may both be coupled to the interposer 212 by a number of internal connectors (e.g., micro-bumps 211). The interposer 212 may include channels 205 (e.g., an interfacing or a connecting circuit) that electrically couple the processor 210 and the memory device 202 through the corresponding micro-bumps 211. While three channels 205 are shown in FIG. 2A, greater or fewer numbers of channels 205 may be used. The interposer 212 may be coupled to the package substrate by one or more additional connections (e.g., intermediate bumps 213, such as C4 bumps).

The package substrate 214 can provide an external interface for the SiP 200. The package substrate 214 can include external bumps 215, some of which may be coupled to the processor 210, the memory device 202, or both. The package substrate may further include direct access (DA) bumps coupled through the package substrate 214 and interposer 212 to the interface die 204.

Unlike the SiP 100 of FIG. 1A, the SiP 200 can include a memory controller 209 within the memory device 202 instead of the processor 210. For the illustrated example, the interface die 204 can include the memory controller 209. The memory controller 209 can be generally similar to the memory controller 109 of FIG. 1A, such as for the overall function. In some embodiments, the memory controller 209 can be different, such as regarding separate write and read circuit paths/connections, and the details of such differences are described further below.

Additionally, to further facilitate the functions of the memory controller 209 within the memory device 202, the memory device 202 can include a circuit interface fabric 250. In some embodiments, the circuit interface fabric 250 can include a DRAM Interface Fabric (DIFF) circuit on the interface die 204. The circuit interface fabric 250 can include circuitry, electrical connections, and/or arrangements thereof configured to facilitate communications between the processor 210 and the core dies 206 through the TSVs 208. Stated differently, the circuit interface fabric 250 can provide the adjustments in the circuitry for implementing the memory controller 209 at the memory device 202.

The interface die 204 can include a memory-local cache 222 to facilitate fast and power-efficient memory communications between the memory device 202 and the processor 210. The memory-local cache 222 can include similar circuitry (e.g., SRAM) as the processor-local cache 111. The memory-local cache 222 can be located between the processor 210 and the memory controller 209. In other words, from the perspective of the processor 210, the memory-local cache 222 can be implemented before the memory controller 209 and remain directly accessible (e.g., using the PHY connection circuits) to the processor 210.

In some embodiments, the memory-local cache 222 can be configured to receive memory communications from the processor 210 directly through the communication circuits (e.g., the PHY circuits) and the selected memory channels that are coupled to discrete sections of the memory-local cache 222. Stated differently, the memory-local cache 222 can be grouped or separated according to memory channels. In such embodiments, the memory device 202 can couple the individual memory channels connecting the discrete sections of the memory-local cache 222 to a separate circuit, or logic, that is configured to select appropriate memory channels for communicating and implementing cache operations or memory operations (e.g., read and/or write commands) from the processor 210. For the example illustrated in FIG. 2A, the SiP 200 can include a processor-side channel selection circuit 224 at the processor 210. The memory-local cache 222 and corresponding channel selection circuit 224 can be implemented as hardware circuits, software modules, firmware, or a combination thereof to implement memory operations communicated between the devices. Accordingly, the memory-local cache 222 (e.g., and corresponding circuit 224) can provide improvements in access latency reduction and power/heat metrics for the SiP200 in comparison to the SiP 100. Details regarding the memory-local cache 222 and channel selection circuit 224 are described below.

### Memory-local cache and Channel Selection Circuits

To further describe the memory-local cache, FIG. 2B shows a schematic block diagram of a processor (e.g., the processor 210) and a memory device (e.g., the memory device 202) in accordance with an embodiment of the present technology. In providing context for the memory-local cache, the processor 210 can include a physical interface (PHY) 251a circuit, such as transmitters, receivers, signal drivers, and/or the like, configured to facilitate the exchange of electrical signals with the memory device 102. Differing from the PHY 151a implemented in HBM applications, the PHY 251a can have a device-to-device (D2D) PHY interface configuration (e.g., a custom PHY different from the JEDEC HBM configuration). In some embodiments, the D2D PHY 251a can have a standard configuration (e.g., Universal Chiplet Interconnect Express (UCIe)).

The PHY 251a can be coupled to the memory device 202 and the interface die 204 therein using channels (e.g., the channels 205 of FIG. 2A) or similar connections within the interposer 212 of FIG. 2A. The interface die 204 can include a PHY 251b circuit that implements the communications for the memory device 202. Accordingly, the PHY 251b can match or correspond to the PHY 251a. For example, the PHY 251b can be configured according to the D2D PHY interface configuration instead of the JEDEC HBM standards.

The memory controller 209 can be configured to control the memory-related communications between the PHY 251b and the circuit interface fabric 250. For example, the memory controller 209 can receive and initially process memory read/write commands that reference locations within the core dies 206 (e.g., DRAM). The memory controller 209 can translate between virtual memory addresses and physical memory addresses to enable access to the core dies 206. The memory controller 209 can utilize PHY 251b for communicating with the PHY 251a and utilize the circuit interface fabric 250 for internally communicating with the core dies 206 through core interface 253 (e.g., the TSVs 208 of FIG. 2A).

As described above, the data communicated between the PHY 251a and the PHY 251b can include data for, or from, the memory-local cache 222 of the memory device 202. In other words, the PHY 251a and the PHY 251b can enable the processor 210 to directly access the memory-local cache 222. Also, the processor 210 can directly access the memory-local cache 222 since the memory -local cache 222 is located before the controller 209.

In some embodiments, the memory-local cache 222 can include extensions or additions of the largest/slowest level of the processor-local cache memory 111. In other embodiments, the memory-local cache 222 can correspond to a next larger/slower level after the last level of the processor-local cache memory 111. Similar to the processor-local cache 111, the processor 210 can determine whether the sought data is within the fastest memory and then move to the next level in the event of a miss. In iteratively reviewing the cache for a potential hit, the processor 210 can examine the memory-local cache 222 after or at the end of reviewing the processor-local cache 111 and before moving on to the next category/type of memory (e.g., DRAM). To transmit memory communications (e.g., cache read and/or write commands) to select memory channels of the memory-local cache 222, the processor 210 can include the channel selection circuit 224, as shown in FIG. 2B. In some alternative embodiments, the memory device 202 can include the channel selection circuit 224 located between the memory-local cache 222 and the memory controller 209.

FIG. 2C illustrates further details of the circuit interface fabric 250. FIG. 2C is a circuit diagram of the memory device in accordance with an embodiment of the present technology. As described above, the memory controller 209 can have similar components as the PHY 151a of FIG. 1C that are implemented in the interface die 204 of FIG. 2A. Further, the memory controller 209 can be connected to the circuit interface fabric 250 using die-internal connections 279 that differ from the connections between the PHY 151a and the PHY 151b of FIG. 1C. The circuit interface fabric 250 can include the signal connection points and circuit paths, electrical components within the circuit paths, arrangement of the components, connections to the TSVs, or a combination thereof.

While the data for the memory controller 109 of FIG. 1A were communicated through die-external connections (e.g., the channels within the interposer of FIG. 1A) with the processor 110 of FIG. 1A, the data for the circuit interface fabric 250 can be communicated over the die-internal connections 279. For the HBM applications, the connection between the memory controller 209 and the circuit interface fabric 250 can differ from the JEDEC HBM requirements. In some embodiments, the DQ channel can include dedicated write connections (e.g., unidirectional write DQ or WDQ bus 280) separate from dedicate read connections (e.g., unidirectional read DQ or RDQ bus 285) instead of the bidirectional DQ bus 180 of FIG. 1C. Accordingly, the memory controller 209 and the circuit interface fabric 250 can each include corresponding circuit paths, such as 291 and 295, and internal connections. The separate RDQ bus 285 and the WDQ bus 280 can provide reduced Read to Write Bus Turnaround time (tRTW) since separate dedicated circuits are utilized for the corresponding unidirectional connections.

In some embodiments, the WDQ bus 280 and the RDQ bus 285 can each have a bus width 282 (e.g., a number of parallel connections) greater than the bidirectional DQ bus 180. In comparison to the bus width 182 of FIG. 1C of 32 for JEDEC HBM DQs, the circuit interface fabric 250 in the example illustrated in FIG. 2A can have the bus width 282 of 256 (e.g., [255:0]). Accordingly, to achieve the same throughput, the circuit interface fabric 250 can utilize a burst length (BL) lower than that of the bidirectional DQ bus 180. For example, the BL for the WDQ bus 280 and the RDQ bus 285 can be 1 in comparison to the BL of 8 for the JEDEC HBM bidirectional DQ bus 180. Stated differently, the circuit interface fabric 250 can facilitate a more parallel communication across the wider write and read buses in comparison to the more serial communications of the JEDEC HBM DQs.

The wider connections of the circuit interface fabric 250 and/or the corresponding memory controller 209 can further enable a communication speed 283 that is lower than the communication speed 183 of FIG. 1C, such as from 12 Gbps of the JEDEC interface to 1.5 Gbps, to achieve the same throughput (e.g., 3 TB/s). Thus, the wider bus connections of the circuit interface fabric 250 and/or the corresponding memory controller 209 can allow longer time windows to process each bit, thereby reducing errors and power consumptions typically associated with higher frequency signal processing.

Regarding the different timing signals, the circuit interface fabric 250 can coordinate or time the write data using the CLK signal instead of the WDQS signal 184 of FIG. 1C based on the separate read and write buses. Accordingly, the circuit interface fabric 250 eliminate the WDQS clock domain in view of the CLK domain. Further, by eliminating the WDQS domain, the synchronizing flip flops (FFs) 186 of FIG. 1C can be eliminated from the communication chain. In other words, the circuit interface fabric 250 can directly provide the write data to the corresponding TSVs using the CLK signal and without the synchronization required for JEDEC HBM write communications.

As an illustrative example, the circuit interface fabric 250 can include (1) a set of write receiver circuits 290 configured to receive the write data from the controller 209 over the WDQ bus 280 and (2) a set of read transmitter circuits 295 configured to send the read data to the controller 209 over the RDQ bus 285. Each of the write receiver circuits 290 can include (a) a signal detector 291 (e.g., an op amp or a similar signal receiver) receiving the electrical signals representative of the write data and (b) a bit identifier 292 (e.g., a flip flop) configured to identify bit values associated with the received electrical signal. The bit identifier 292 can operate directly based on the CLK 181 (e.g., without alignment or processing with another signal, such as the WDQS) to sample the incoming signal and provide an output bit stream directly to the TSVs 208. Similarly, each of the read transmitter circuits 295 can include a bit identifier 296 operating directly based on the CLK 181 and with a signal transmitter 297 to generate signals representative of the read data.

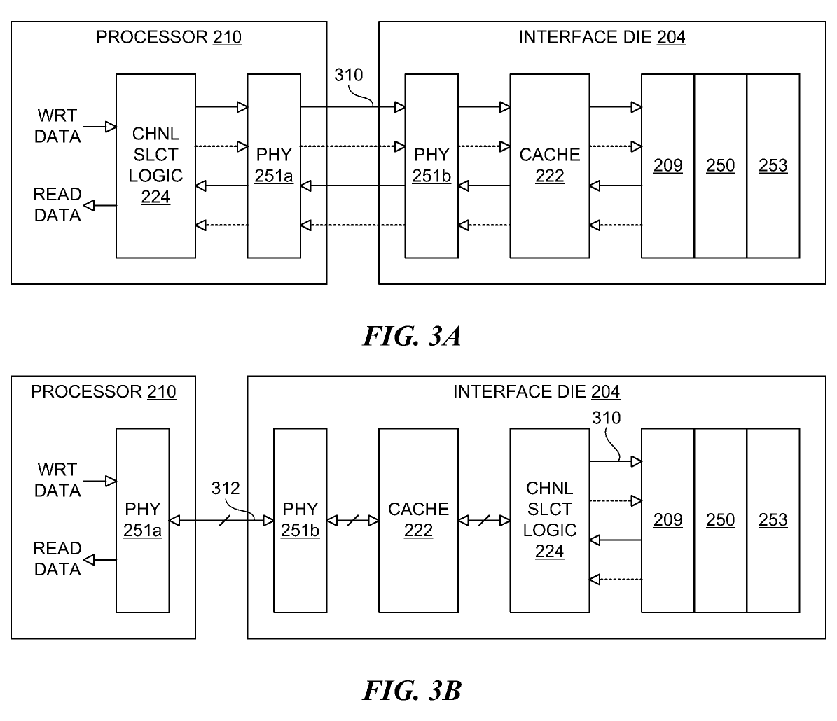

FIGS. 3A and 3B illustrate further details of the memory-local cache 222 and the channel selection circuit 224. FIG. 3A is a first example of a memory-local cache in accordance with an embodiment of the present technology. As shown in FIG. 3A, the processor 210 includes a channel selection circuit 224 that is coupled to the PHY 251a of the processor 210. In this embodiment, the channel selection circuit 224 is configured to receive access/retrieval commands for the memory-local cache 222. Further, the channel selection circuit 224 is configured to select one or more memory channels 310 (e.g., of the memory-local cache 222) for communicating with the memory device 202 based on the received memory operations and/or corresponding memory addresses. For example, the channel selection circuit 224 can compare a received virtual memory address (or portions thereof) to a stored lookup table and identify the specific memory channel of the memory-local cache 222 that connects to the indexed cache set. As shown in FIG. 3A, the electrical connections between the PHY 251a and 251b can be aligned to the memory channels 310 of the memory-local cache 222. As a result, the channel selection circuit 224 can transmit communications between the processor 210 and the memory-local cache 222 of the memory device 202 directly through individual memory channels 310 of the memory-local cache 222.

As an illustrative example, the processor 210 can access write data intended to be stored at the memory device 202 of FIG. 2B. The write data can include identifiers for memory locations within the memory-local cache 222, such as memory addresses and/or cache tags, for storing a payload. Accordingly, the channel selection circuit 224 can identify a memory channel 310 connecting select cache memory of the memory-local cache 222 that maps to the memory address (or components thereof) of the write operation and send the write data to the select cache memory of the memory-local cache 222 via electrical connections of PHY 251a that aligns to the identified memory channel 310. As a result, the selected memory channel 310 of the memory-local cache 222 can receive the write data from the processor 210 for storage via electrical connections of PHY 251b that aligns to the memory channel 310.

For read operations, the processor 210 can provide the read command to the channel selection circuit 224. The channel selection circuit 224 can identify a memory channel 310 of the memory-local cache 222 that maps to the memory addresses of the received read command. Accordingly, the channel selection circuit 224 can provide the read command to the memory-local cache 222 of the memory device 202 via the selected memory channel 310, and the memory-local cache 222 can output (e.g., via the selected memory channel 310) the requested data from the commanded address.

In some embodiments, the memory channels 310 of the memory-local cache 222 and the memory controller 209 can be aligned, such that each memory controller 209 of the memory device 202 is linked to a separate memory channel 310 of the memory-local cache 222. In this embodiment, the processor 210 can communicate read and/or write memory commands to select memory addresses of the core dies 206. For example, the channel selection circuit 224 can identify a memory channel 310 of the memory-local cache 222 that corresponds to the memory controller 209 for the commanded address. Accordingly, the channel selection circuit 224 can transmit the memory command, including associated data payloads, to the memory-local cache 222 via the selected memory channel 310, which can pass the received data to downstream circuits such as the processor cores or the memory core dies (e.g., through the memory controller 209, the circuit interface fabric 250, and the TSVs 208).

In some embodiments, the memory-local cache 222 of the memory device 202 can be configured to store persistent data communicated from the processor 210. For example, the processor 210 can perform a write to the memory-local cache 222 through the channel selection circuit 224, such that the corresponding command to the channel selection 224 includes an instruction for updating reserved portions of the accessed memory (e.g., an optional persistence flag and/or bit) of the memory-local cache 222 to indicate that the written data is persistent memory-local cache. Accordingly, the memory device 202 can be configured to skip and/or prohibit memory instructions for modifying stored data of the memory-local cache 222 that includes an activated persistence flag. In other words, the processor 210 can tag select data stored on the memory-local cache 222 to prevent removal and/or replacement of the stored data during a cache flush, or similar memory operations.

FIG. 3B is a second example of a memory-local cache in accordance with an embodiment of the present technology. As shown in FIG. 3B, the processor 210 includes the processor-side PHY 251a for communicating memory commands to and from the interface die 204 of the memory device 202. In this embodiment, the interface die 204 can include the memory-local cache 222 and the channel selection circuit 224. In contrast to the first example memory-local cache of FIG. 3A, the memory-local cache 222 of the memory device 202 is located between and coupled to the memory device-side PHY 251b and the channel selection circuit 224. Further, the channel selection circuit 224 is located between and coupled to the memory-local cache 222 and the memory controller 209 of the memory device 202.

In this embodiment, the processor 210 can be configured to communicate memory commands directly to the memory-local cache 222 via a general bus 312 instead of individual memory channels 310. The processor 210 can send memory commands for data stored on the core dies 206 of the memory device 202 via the general bus 312 and individual memory channels 310 of downstream circuits. As an illustrative example, the processor 210 provide a read command to the channel selection circuit 224 located on the interface die 204 (e.g., via the general bus 312 connection). The channel selection circuit 224 can use memory location identifiers of the read command (e.g., commanded memory addresses) to identify a memory channel 310 for the core dies 206 storing the requested data. The channel selection circuit 224 can pass the read command of the processor 210 (e.g., via the memory controller corresponding to the selected memory channel 310) to downstream circuits such as the processor cores or the memory core dies (e.g., through the memory controller 209, the circuit interface fabric 250, and the TSVs 208).

### Control Flow

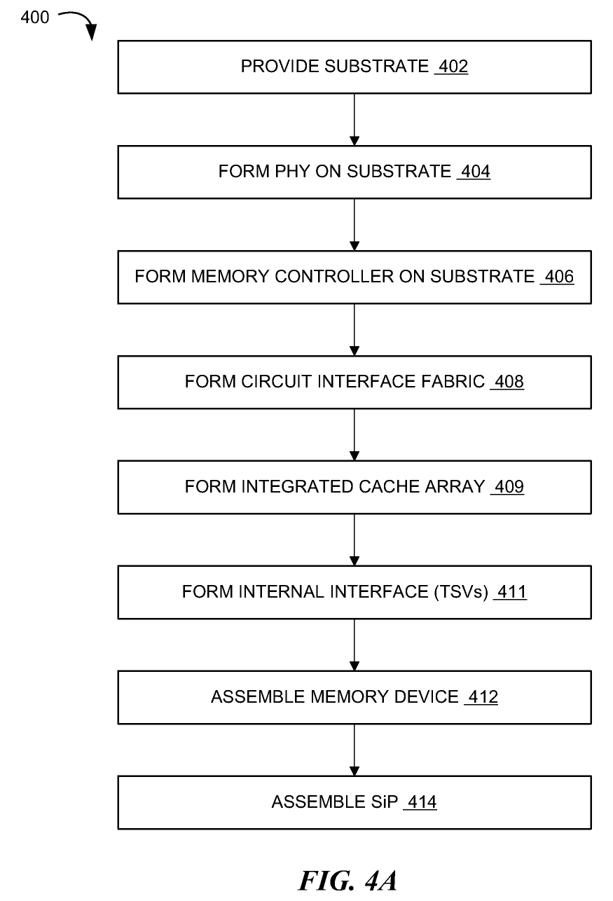

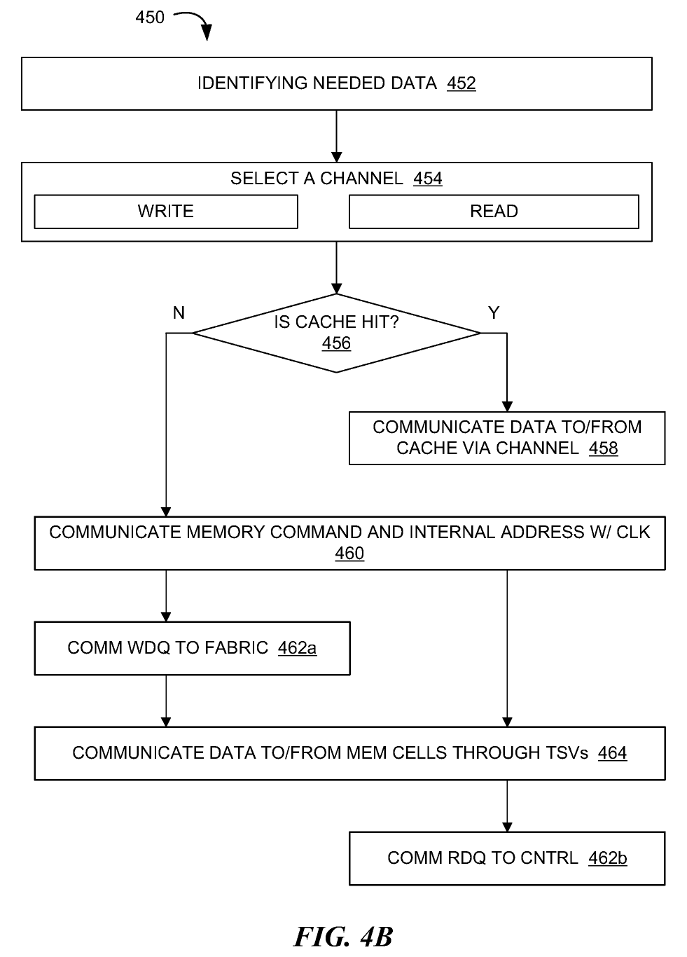

FIG. 4A is a flow diagram illustrating an example method 400 of manufacturing an apparatus (e.g., the SiP 200 of FIG. 2A, the memory device 202 of FIG. 2A, and/or the interface die 204 of FIG. 2A,) in accordance with an embodiment of the present technology. The method 400 can include manufacturing the circuit interface fabric 250 of FIG. 2A, the memory controller 209 of FIG. 2A, the memory-local cache, the channel selection circuit, or a combination thereof on the interface die 204 and/or a corresponding device or SiP.

At block 402, the method 400 can include providing a semiconductor substrate, such as a semiconductor wafer. The semiconductor wafer can be processed to form functional circuitry thereon, such as active components, passive components, electrical connections, power components, and/or the like. At block 404, the method 400 can include forming the PHY 251b configured to communicate signals with an externally located processor (e.g., the processor 210 of FIG. 2A) for implementing writes to locations in the core dies 206 of FIG. 2A and reads from the locations in the dies 206. As described above, the PHY 251b can have a D2D communication configuration that is different from the JEDEC HBM requirements for communications between the PHY 151a of FIG. 1B and the PHY 151b of FIG. 1B.

At block 406, the method 400 can include forming a memory controller circuit (e.g., the memory controller 209) coupled to the PHY and configured to control and manage flow of data between the processor and the core dies. The memory controller 209 can have dedicated read connections and corresponding circuit paths separate from dedicated write connections/circuit paths.

At block 408, the method 400 can include forming a circuit interface fabric (e.g., the circuit interface fabric 250) connected to the memory controller. Forming the circuit interface fabric can include forming the die-internal connections 279 of FIG. 3A. Accordingly, the method 400 can include forming a WDQ bus, a RDQ bus 285, the connection for a CLK. The WDQ bus and the RDQ bus can each be unidirectional for communicating the write data and the read data, respectively.

The WDQ bus and the RDQ bus can each have the bus width that is greater than that of the JEDEC HBM bidirectional DQ standardized bus width. For example, the bus width can be 33bit width or greater (e.g., 256 bit width). Further, the circuit interface fabric 250 can utilize the communication speed that is less than the standardized communication speed for the JEDEC HBM communication. For example, the communication speed can be less than 12 Gbps (e.g., 1.5Gbps) for communicating data with the memory controller 209.

To facilitate the WDQ bus and the RDQ bus, the circuit interface fabric 250 can be formed with the set of write receiver circuits and the set of set of read transmitter circuits. Such circuits can be configured to operate directly based on the CLK without adjusting/aligning with the WDQS. Accordingly, the circuit interface fabric 250 can be formed without synchronizing FFs 186 of FIG. 1C.

At block 409, the method 400 can include forming a memory-local cache array (e.g., the memory-local cache 222 of FIG. 2A-3D) coupled to and located between the PHY and memory controller. The memory-local cache array can be configured to provide direct data access (e.g., without utilizing the memory controller) for the processor 210. Forming the cache memory can include forming an set of SRAM or other faster data storage circuits. In some embodiments, the data storage circuit can be arranged according to channels such that each channel of the cache memory is separately coupled to the PHY. In some embodiments, forming the cache memory can include electrically coupling the memory array to the PHY via a generic bus connection.

In some implementations, the method 400 at block 409 can include forming a channel selection circuit (e.g., the circuit 224 of FIG. 2A-3D) coupled to the memory-local cache array and the memory controller. In this embodiment, the memory-local cache array can be coupled to the PHY and the channel selection circuit. The channel selection circuit can be configured to identify appropriate memory channels for communicating memory commands from the processor 210 to downstream circuits such as the memory-local cache or the memory core dies (e.g., through the memory controller 209, the circuit interface fabric 250, and the TSVs 208).

At block 411, the method 400 can include forming TSVs (e.g., the TSVs 208 of FIG. 2A as an example of the core interface 253 of FIG. 2B) connected to the circuit interface fabric. The TSVs can be formed coupling the WDQ connection point and the RDQ connection point to the core dies 206 having the memory cells and stacked on the HBM interface die 204. The TSVs can be directly connected to the write receiver circuits 290 and the read transmitter circuits 295 without intervening circuitry (e.g., the synchronizing FFs 186).

At block 412, the method 400 can include assembling a memory device (e.g., the memory device 202) using the processed substrate. The memory device can be formed by stacking the memory dies 206 over the interface die 204. In some embodiments, the memory device can be formed by stacking and bonding the wafers (e.g., the wafers having the memory circuits over the wafer having the interface circuits) and then singluating the wafer stack to form the singulated die stacks.

At block 414, the method 400 can include assembling a SiP or a portion thereof using the memory device. For example, the method 400 can include attaching the memory device 202 over the interposer 212 of FIG. 2A, mounting the processor 210 over the interposer 212, mounting the interposer 212 over the package substrate 214 of FIG. 2A, or a combination thereof.

FIG. 4B is a flow diagram illustrating an example method 450 of operating an apparatus (e.g., the SiP 200 of FIG. 2A, the processor 210 of FIG. 2A, the memory device 202 of FIG. 2A, the interface die 204 of FIG. 2A, etc.) in accordance with an embodiment of the present technology. The method 450 can be for operating the processor 210 to access the memory-local cache 222 of FIG. 2A.

At block 452, the method 450 can include the processor 210 identifying the needed data (e.g., to recall payload data or to obtain next set of instructions), such as during execution of software instructions. In some embodiments, the need to access data can trigger the channel selection circuit 224 (e.g., of the processor 210) to identify a data channel associated with the needed data. For example, the channel selection circuit 224 can have a mapping or a predetermined rule for identifying the memory channel based on a tag for the needed data.

At block 454, the method 450 can include generating memory command and selecting the memory channel 310 of the memory-local cache 222 for transmitting the command and/or virtual address. For example, the channel selection circuit 224 can identify the memory channel 310 of the memory-local cache 222 that connects to a select cache memory (e.g., a cache set) indexed to the received virtual address, or components thereof. Stated differently, the channel selection circuit 224 can use a stored mapping (e.g., similar to a page table) to determine the corresponding memory channel 310 through which a generated memory command will be transmitted (e.g., to the memory-local cache 222 of memory device 202). The generated memory command can include instructions for validating the selected cache memory (e.g., of the memory-local cache 222) prior to executing the corresponding read/write command. For example, the generated memory command can include a tag and/or identifier (e.g., a portion of the received virtual address) that can be compared with a reserved portion of the selected cache memory to determine whether access of the selected cache memory is valid (e.g., a cache hit or miss).

At decision block 456, the method 450 can include determining whether communication of the generated memory command resulted in a valid cache memory access (e.g., cache hit/miss of the processor-local cache 111 and then the memory-local cache 222). For example, the memory-local cache 222 can compare the tag and/or identifier of the generated memory command to the corresponding stored tag and/or identifier at the selected cache memory (e.g., of the memory-local cache) to output an indicator for a tag match (e.g., a cache hit) or mismatch (e.g., a cache miss). The processor 210 can iteratively search across different types of cache memory before moving to the next hierarchical category of memory (e.g., to DRAM). For example, the processor 210 can start from L1 cache and move toward slower/bigger cache. The processor 210 can review the memory-local cache 222 last.

In response to a validation indicator (e.g., a cache hit), the method 450 can communicate data to and/or from the memory-local cache 222 when the data is found outside of the processor 220, as further described below with respect to block 458. In response to an invalidation indicator (e.g., a cache miss), the method 450 can attempt to implement the generated memory command at the core dies 206 via the memory controllers 209.

At block 458, when the result of the decision block 456 corresponds to a valid cache memory access (e.g., a cache hit at the memory-local cache 222), the method 450 can include communicating the generated memory command via the selected memory channel 310 of the memory-local cache 222. The channel selection circuit 224, or a combination of related circuits and/or logics of processor 210, can communicate the memory command to the memory-local cache 222 through the PHY 251a of FIG. 2B coupled to the selected memory channel 310. Similarly, the memory-local cache 222 can receive the generated memory command via electrical connections of the PHY 251b of FIG. 2B that correspond to the selected memory channel 310. For a write operation, the memory device 202 can be configured to store the data payload received from the communicated memory command at the specified memory channel 310 of the memory-local cache 222. For a read operation, the memory device 202 can be configured to send the targeted read data through the PHY 251b of FIG. 2B to the processor 210. For the read operation, the memory device 202 can be configured to send the read data stored in the memory channel 310 of the memory-local cache 222 to the processor 210 via the PHY 251a and 251b interface.

At block 460, when the result of the decision block 456 corresponds to an invalid cache memory access (e.g., a cache miss at the memory-local cache 222),, the method 450 can include communicating memory command and internal address with the CLK to the circuit interface fabric 250. The memory controller 209 can communicate the generated memory command and the interna/physical address to the circuit interface fabric 250. The memory controller 209 can communicate the command and address over a corresponding CMD/ADD connection. The memory controller 209 can send the CLK over the corresponding connection.

At block 462a, when the commanded operation is a write operation, the method 450 can include communicating the write data to the circuit interface fabric 250. The memory controller 209 can send the targeted write data over the corresponding dedicated unidirectional bus (e.g., the WDQ) to the circuit interface fabric 250.

At block 464, the method 450 can include communicating the data to/from the memory cells through the internal interface (e.g., TSVs). The circuit interface fabric 250 can communicate the targeted data between the circuit path and the internal interface 253. For the write command, the circuit interface fabric 250 can communicate the received write data from write receiver circuits to the TSVs 208. For the read command, the circuit interface fabric 250 can communicate the read data from the TSVs 208 to read transmitter circuits.

At block 462b, when the commanded operation is a read operation, the method 450 can include communicating the read data from the circuit interface fabric 250 to the memory controller 209. The circuit interface fabric 250 can send the targeted read data over the corresponding dedicated unidirectional bus (e.g., the RDQ) to the memory controller 209.

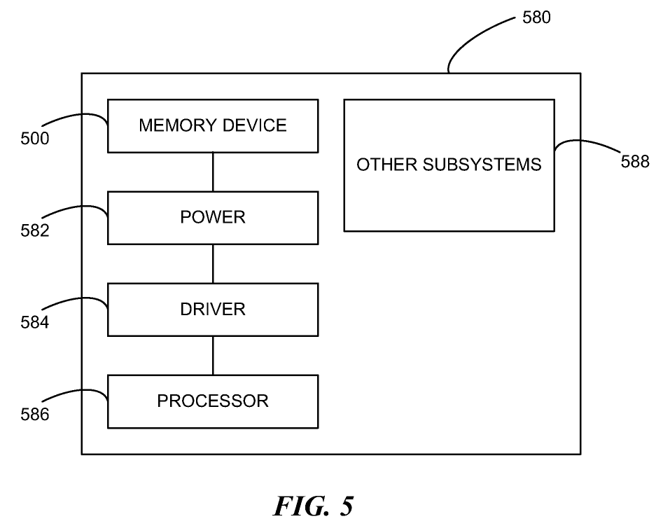

FIG. 5 is a schematic view of a system that includes an apparatus in accordance with embodiments of the present technology. Any one of the foregoing apparatuses (e.g., memory devices) described above with reference to FIGS. 2A-4B can be incorporated into any of a myriad of larger and/or more complex systems, a representative example of which is system 580 shown schematically in FIG. 5. The system 580 can include a memory device 500, a power source 582, a driver 584, a processor 586, and/or other subsystems or components 488. The memory device 500 can include features generally similar to those of the apparatus described above with reference to FIGS. 2A-4B and can therefore include various features for performing a direct read request from a host device. The resulting system 580 can perform any of a wide variety of functions, such as memory storage, data processing, and/or other suitable functions. Accordingly, representative systems 580 can include, without limitation, hand-held devices (e.g., mobile phones, tablets, digital readers, and digital audio players), computers, vehicles, appliances and other products. Components of the system 580 may be housed in a single unit or distributed over multiple, interconnected units (e.g., through a communications network). The components of the system 580 can also include remote devices and any of a wide variety of computer readable media.

From the foregoing, it will be appreciated that specific embodiments of the technology have been described herein for purposes of illustration, but that various modifications may be made without deviating from the disclosure. In addition, certain aspects of the new technology described in the context of particular embodiments may also be combined or eliminated in other embodiments. Moreover, although advantages associated with certain embodiments of the new technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

In the illustrated embodiments above, the apparatuses have been described in the context of DRAM devices. Apparatuses configured in accordance with other embodiments of the present technology, however, can include other types of suitable storage media in addition to or in lieu of DRAM devices, such as, devices incorporating NAND-based or NOR-based non-volatile storage media (e.g., NAND flash), magnetic storage media, phase-change storage media, ferroelectric storage media, etc.

The term "processing" as used herein includes manipulating signals and data, such as writing or programming, reading, erasing, refreshing, adjusting or changing values, calculating results, executing instructions, assembling, transferring, and/or manipulating data structures. The term data structure includes information arranged as bits, words or code-words, blocks, files, input data, system-generated data, such as calculated or generated data, and program data. Further, the term "dynamic" as used herein describes processes, functions, actions or implementation occurring during operation, usage or deployment of a corresponding device, system or embodiment, and after or while running manufacturer's or third-party firmware. The dynamically occurring processes, functions, actions or implementations can occur after or subsequent to design, manufacture, and initial testing, setup or configuration.

The above embodiments are described in sufficient detail to enable those skilled in the art to make and use the embodiments. A person skilled in the relevant art, however, will understand that the technology may have additional embodiments, and that the technology may be practiced without several of the details of the embodiments described above with reference to FIGS. 2A-5.

### Further Examples

In some embodiments, the techniques described herein relate to a High-Bandwidth Memory (HBM) interface die configured to be stacked with one or more core memory dies, the HBM interface die including: a physical layer interface circuit (PHY) configured to communicate with a processor for implementing write operations to locations in the core memory dies or read operations from the locations in the memory dies; a set of Through Silicon Vias (TSVs) communicatively coupled to the PHY and configured to provide vertical communicative connections to the core memory dies; a memory controller located between and coupled to the PHY and the TSVs within the interface die, the memory controller configured to control and manage flow of data associated with the communication between the processor and the core memory dies for the read and write operations; a circuit interface fabric connecting the memory controller to the TSVs, the circuit interface fabric connected using a set of dedicated write data connections (WDQ) and a set of dedicated read DQ connections (RDQ) respectively configured for communicating the data between the memory controller and the core memory dies through the TSVs; and a cache memory array coupled to the PHY and the memory controller of the interface die, the cache memory including memory cells for storing data from communication with the processor.

In some embodiments, the techniques described herein relate to a HBM interface die, wherein the PHY is configured to communicate a message with the processor for implementing a write operation to a location in the cache memory array or a read operation from the location in the cache memory array.

In some embodiments, the techniques described herein relate to a HBM interface die, wherein: the PHY and the memory controller are communicatively coupled via direct electrical connections through separate memory channels of the cache memory array; and the PHY is configured to communicate the message including data from the processor via the separate memory channels of the cache memory array.

In some embodiments, the techniques described herein relate to a HBM interface die, wherein the PHY is coupled to a channel selection circuit external to the HBM interface die and configured to communicate the message including data from the processor via one or more memory channels of the cache memory array assigned by the channel selection circuit.

In some embodiments, the techniques described herein relate to a HBM interface die, wherein the PHY is configured to send the message including data stored in the one or more memory channels of the cache memory array as a response to the processor for the read operation.

In some embodiments, the techniques described herein relate to a HBM interface die, wherein the PHY is configured to receive the message including a flag for the one or more memory channels of the cache memory array to store persistent data.

In some embodiments, the techniques described herein relate to a HBM interface die, wherein each separate memory channel of the cache memory array has a memory storage capacity of up to 2MB.

In some embodiments, the techniques described herein relate to a HBM interface die, wherein: the communicated message with the processor is a first message; and the PHY is configured to communicate a second message with the processor for implementing a second write operation to a location in the core memory dies or a second read operation from the location in the core memory dies in response to a failed memory operation of the first communicated message.

In some embodiments, the techniques described herein relate to a HBM interface die, further including: a channel selection circuit located between and coupled to the cache memory array and the memory controller of the interface die, the channel selection circuit configured to communicate the messages with the processor via one or more memory channels of the cache memory array assigned by the channel selection circuit.

In some embodiments, the techniques described herein relate to a High-Bandwidth Memory (HBM) device including: at least one core die configured to store data; and an interface die stacked and communicatively coupled with the core die, the interface die including: a memory controller configured to control and manage flow of data between a processor and the core dies; and a cache memory array coupled to the memory controller and including memory cells for storing the data communicated with the processor.

In some embodiments, the techniques described herein relate to a HBM device, wherein the interface die includes a physical layer circuit (PHY) configured to communicate a message with the processor for implementing a write operation to a location in the cache memory array or a read operation from the location in the cache memory array.

In some embodiments, the techniques described herein relate to a HBM device, wherein: the PHY and the memory controller are communicatively coupled via direct electrical connections through separate memory channels of the cache memory array; and the PHY is configured to communicate the message including data from the processor via the separate memory channels of the cache memory array.

In some embodiments, the techniques described herein relate to a HBM device, wherein the PHY is coupled to a channel selection circuit external to the HBM device and configured to communicate the message including data from the processor via one or more memory channels of the cache memory array assigned by the channel selection circuit.

In some embodiments, the techniques described herein relate to a HBM device, wherein the PHY is configured to send the message including data stored in the one or more memory channels of the cache memory array as a response to the processor for the read operation.

In some embodiments, the techniques described herein relate to a HBM device, wherein the PHY is configured to receive the message including a flag for the one or more memory channels of the cache memory array to store persistent data.

In some embodiments, the techniques described herein relate to a HBM device, wherein: the communicated message with the processor is a first message; and the PHY is configured to communicate a second message with the processor for implementing a second write operation to a location in the at least one core die or a second read operation from the location in the at least one core die in response to a failed memory operation of the first communicated message.

In some embodiments, the techniques described herein relate to a method of operating a High-Bandwidth Memory (HBM) device, the method including: accessing a read data in response to a read command from an external host device, wherein the read data is obtained from a cache memory array of the HBM device; and sending the read data to the external host device as a response to the read command.

In some embodiments, the techniques described herein relate to a method, wherein the read command is received from the external host device via a physical layer circuit (PHY) coupled to at least one memory channel of the cache memory array, and wherein the method further includes: retrieving data stored in the at least one memory channel of the cache memory array for the accessed read data.

In some embodiments, the techniques described herein relate to a method, further including: receiving, from the external host device, a message for a persistent write operation at one or more memory channels of the cache memory array, the message including a payload data; storing the payload data for the persistent write operation in the cache memory array, wherein the one or more memory channels of the cache memory array are labeled as persistent memory.

In some embodiments, the techniques described herein relate to a method, wherein the HBM device includes memory controllers coupled to the cache memory array, and wherein the method further includes: receiving, via the at least one memory channel of the cache memory array, a command from the external host device for reading data from at least one core memory die coupled to the memory controllers; accessing the data from the at least one core memory die via at least one memory controller coupled to the at least one memory channel; and sending the accessed data to the external host device as a response to the received command.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any specific portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A High-Bandwidth Memory (HBM) interface die configured to be stacked with one or more core memory dies, the HBM interface die comprising:
a physical layer interface circuit (PHY) configured to communicate with a processor;
a set of Through Silicon Vias (TSVs) communicatively coupled to the PHY and configured to provide communicative connections to the core memory dies;
a memory controller located between and coupled to the PHY and the TSVs within the interface die, the memory controller configured to control and manage access to the core memory dies for the read and write operations;
a circuit interface fabric connecting the memory controller to the TSVs, the circuit interface fabric connected using a set of dedicated write data connections (WDQ) and a set of dedicated read DQ connections (RDQ) respectively configured for communicating the data between the memory controller and the core memory dies through the TSVs; and
cache memory connected between the PHY and the memory controller of the interface die, the cache memory configured to store data directly accessible by the processor through the PHY.

2. The HBM interface die of claim 1, wherein the PHY is configured to communicate a message with the processor for implementing a cache write operation to a location in the cache memory or a cache read operation from the location in the cache memory array.

3. The HBM interface die of claim 2, wherein:
the cache memory is arranged according to memory channels; and
the PHY is configured to communicate the message including data from the processor via the separate memory channels of the cache memory array.

4. The HBM interface die of claim 3, wherein the PHY is coupled to a channel selection circuit external to the HBM interface die and configured to communicate the message including data from the processor via one or more memory channels of the cache memory assigned by the channel selection circuit.

5. The HBM interface die of claim 4, wherein the PHY is configured to send the message including data stored in the one or more memory channels of the cache memory array as a response to the processor for the cache read operation.

6. The HBM interface die of claim 4, wherein the PHY is configured to receive the message including a flag for the one or more memory channels of the cache memory array to persistently store data.

7. The HBM interface die of claim 3, wherein each separate memory channel of the cache memory array has a memory storage capacity of up to 2MB.

8. The HBM interface die of claim 3, wherein:
the communicated message with the processor is a first message; and
the PHY is configured to communicate a second message with the processor for implementing a second write operation to a location in the core memory dies or a second read operation from the location in the core memory dies in response to a failed memory operation of the first communicated message.

9. The HBM interface die of claim 2, further comprising:
a channel selection circuit located between and coupled to the cache memory array and the memory controller of the interface die, the channel selection circuit configured to communicate the messages with the processor via one or more memory channels of the cache memory array assigned by the channel selection circuit.

10. A High-Bandwidth Memory (HBM) device comprising:
at least one core die configured to store data; and
an interface die stacked and communicatively coupled with the core die, the interface die including:
a memory controller configured to control and manage flow of data between a processor and the core dies; and
a cache memory coupled to and located before the memory controller, the cache memory configured to store data directly accessible to the processor.

11. The HBM device of claim 10, wherein the interface die includes a physical layer circuit (PHY) configured to communicate a message with the processor for implementing a write operation to a location in the cache memory array or a read operation from the location in the cache memory array.

12. The HBM device of claim 11, wherein:
the PHY and the memory controller are communicatively coupled via direct electrical connections through separate memory channels of the cache memory array; and
the PHY is configured to communicate the message including data from the processor via the separate memory channels of the cache memory array.

13. The HBM device of claim 12, wherein the PHY is coupled to a channel selection circuit external to the HBM device and configured to communicate the message including data from the processor via one or more memory channels of the cache memory array assigned by the channel selection circuit.

14. The HBM device of claim 13, wherein the PHY is configured to send the message including data stored in the one or more memory channels of the cache memory array as a response to the processor for the read operation.

15. The HBM device of claim 13, wherein the PHY is configured to receive the message including a flag for the one or more memory channels of the cache memory array to store persistent data.

16. The HBM device of claim 12, wherein:
the communicated message with the processor is a first message; and
the PHY is configured to communicate a second message with the processor for implementing a second write operation to a location in the at least one core die or a second read operation from the location in the at least one core die in response to a failed memory operation of the first communicated message.

17. A method of manufacturing a High-Bandwidth Memory (HBM) device, the method comprising:
providing a semiconductor substrate corresponding to an interface die of the HBM;
forming a memory controller configured to access a downstream memory circuit;
forming cache memory on the semiconductor substrate and upstream from the memory controller, the cache memory configured to be directly accessible to an upstream external processor; and
forming a physical layer (PHY) circuit coupled to the cache memory and the memory controller, wherein the PHY circuit is configured to communicatively couple the interface die to the upstream external processor.

18. The method of claim 17, wherein the PHY circuit is configured to facilitate the upstream external processor to review data stored in the cache memory located in the interface die for a hit or a miss.

19. The method of claim 17, wherein the cache memory located in the interface die is configured as a highest level of cache memory having a larger size and a slower access speed than other cache memory available to the upstream external processor.

20. The method of claim 17, wherein the cache memory is arranged according to memory channels that correspond to arrangement and accessibility of memory cells in the core dies of the HBM device.
